(19) United States
(12) Patent Application Publication
(10) Pub. No.: US 2019/0334811 A1
(43) Pub. Date: Oct. 31, 2019

(54) PRIORITY ADJUSTMENTS FOR ELECTION PROCESSES OF ROUTERS

(71) Applicant: HEWLETT PACKARD ENTERPRISE DEVELOPMENT LP, Houston, TX (US)

(72) Inventors: Anil Raj, Bangalore (IN); Anoop Govindan Nair, Bangalore (IN); Celestian K. Sebastian, Bangalore (IN)

(21) Appl. No.: 15/962,086

(22) Filed: Apr. 25, 2018

(51) Int. Cl. H04L 12/725; H04L 12/751; H04L 12/721; H04L 12/707; H04L 12/703

(52) U.S. Cl. CPC H04L 45/302; H04L 45/026; H04L 45/28; H04L 45/22; H04L 45/12

(57) ABSTRACT

In some examples, a first router includes a communication interface to communicate over a network, and a processor to participate in an election process to determine, based on respective priorities assigned to a plurality of routers including the first router, which of the plurality of routers is an elected router responsible for distributing routing information to another router, and in response to the first router being selected as the elected router in the election process, adjust a priority of the first router for a subsequent election process.

### BACKGROUND

A network includes routers to route data communicated between endpoint devices through the network. Routers perform data routing based on routing information accessible by the routers. Various routing protocols can be employed by the routers. An example routing protocol is the Open Shortest Path First (OSPF) protocol.

### BRIEF DESCRIPTION OF THE DRAWINGS

Some implementations of the present disclosure are described with respect to the following figures.

FIG. 1 is a block diagram of an example network arrangement according to some examples.

FIG. 2 is a block diagram of a router according to some examples.

FIG. 3 is a flow diagram of a process of a router, according to some examples.

FIG. 4 is a block diagram of a router according to further examples.

FIG. 5 is a block diagram of a storage medium storing machine-readable instruction according to additional examples.

FIG. 6 is a flow diagram of a process of a router, according to alternative examples.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

In the present disclosure, use of the term “a,” “an”, or “the” is intended to include the plural forms as well, unless the context clearly indicates otherwise. Also, the term “includes,” “including,” “comprises,” “comprising,” “have,” or “having” when used in this disclosure specifies the presence of the stated elements, but do not preclude the presence or addition of other elements.

In the ensuing discussion, reference is made to a network that operates according to the Open Shortest Path First (OSPF) protocol (such a network is referred to as an “OSPF network”). There are multiple versions of the OSPF protocol, including OSPF v2 and OSPF v3, as examples. In other examples, techniques or mechanisms according to some implementations of the present disclosure are applicable for use with routers in networks that operate according to other routing protocols.

A “router” refers to a device in a network that is responsible for routing data along a route (or equivalently, path) in the network. The data is communicated between a source device and a destination device (or multiple destination devices). The router is able to select from among one of multiple possible routes in the network to route the data. Examples of source and destination devices include desktop computers, notebook computers, server computers, communication nodes, tablet computers, smartphones, wearable devices (e.g., smart watches, smart eyeglasses, head-mounted devices, etc.), game appliances, vehicles, Internet of Things (IoT) devices, and so forth.

A router performs routing of data packets based on network addresses in the data packets, and on routing information accessible by the router. For example, the routing information can be stored on a storage medium of the router, or on a storage medium separate from but accessible by the router.

In an OSPF network, the routing information is in the form of a link state database, which is a network topology map. According to the OSPF protocol, a state of a given route in the network is a cost, and an OSPF algorithm used by a router to route data allows the router to calculate the costs (e.g., based on communication data rates) of the routes to any given destination. The routing information (e.g., the OSPF link state database) is maintained (or more generally, accessible) by each of the routers of the network.

An OSPF network includes multiple network segments, where each network segment can be connected to multiple routers. On a network segment, one of the multiple routers connected to the network segment can be elected as a designated router (DR). A DR is used to reduce network traffic by providing a source for routing updates (e.g., updates to the link state database). The DR can send the routing updates to the other router(s) on the network segment, such as by multicasting the routing updates.

A router on the network segment sends a routing update to the DR (as well as to a backup DR as explained further below). The DR will then send the routing update to all other router(s) on the network segment. In this manner, the routers on the network segment do not have to update each other, but rather, receives the routing updates from a single source (the DR).

The election of a DR on a network segment can be based on priorities of the multiple routers connected to the network segment. A priority can be represented by a value that is assigned to a router or a communication interface of the router (e.g., a higher value can indicate a higher priority, or vice versa). In the ensuing discussion, reference to a priority of a router can refer to the priority assigned to the router, or the priority assigned to a communication interface of the router. If a router has multiple communication interfaces, the multiple communication interfaces can potentially be assigned different priorities (or the same priority).

On the network segment, the router with the highest priority can be elected the DR. If two routers have the same priority, then a tie-breaker can be used to select the DR from the two routers. The tie-breaker can be based on an identifier of each router (router ID), where the identifier can be in the form of a network address such as an Internet Protocol (IP) address. For example, the router having the higher router ID can be elected the DR in case of a tie in the priority between multiple routers.

Election of a backup DR (BDR) is similarly performed based on priorities assigned to routers connected to a network segment. A BDR becomes a DR (i.e., takes over the role of the DR) in response to detecting a problem with a current DR (e.g., the current DR goes down, a fault is experienced at the current DR, and so forth). When a BDR becomes a DR, a new election process can be performed to elect another BDR on the network segment.

A DR may have more communication and processing load placed on the DR than non-DR routers (i.e., routers not selected as a DR or BDR). A network administrator can configure (in a static manner) priorities of routers in an attempt to influence the selection of DRs and BDRs in a way to avoid overburdening any router.

In an example, a given router may be connected to multiple network segments; more specifically, the given router has multiple communication interfaces connected to the respective multiple network segments. If the given router were elected as the DR in each of the multiple network segments, then the given router can become overburdened, since it would have to provide routing updates to routers on multiple segments. By statically configuring priorities of routers on the multiple segments, a network administrator can attempt to cause different routers to be elected DRs/BDRs on different network segments, such as to avoid the situation where one router is a DR on each of multiple segments.

However, the static assignment of priorities to routers may not lead to DR/BDR elections on respective network segments in a manner targeted by the network administrator. Moreover, as routers elected as DRs or BDRs experience problems, then the election of new DRs or BDRs can lead to a scenario where a router becomes overburdened. In addition, deploying powerful routers (routers with large processing capacity in the form of powerful processors and/or large communication capacity in the form of high speed communication interfaces) for use as DRs or BDRs can lead to increased equipment costs.

Although a network administrator can react to detection of routers becoming overburdened by re-adjusting the static priorities assigned to routers, such a process is reactive in nature and is manual, which adds to administrative overhead of the network.

In accordance with some implementations of the present disclosure, automated dynamic priority adjustment techniques or mechanisms allow for priorities of routers to be dynamically adjusted in an automated manner as the routers are elected as DRs or BDRs. Generally, a given router participates in an election process to determine, based on respective priorities assigned to a plurality of routers including the given router, which of the plurality of routers is an elected router (e.g., a DR or BDR of an OSPF network segment) responsible for distributing routing information to another router. In response to the given router being selected as the elected router in the election process, a priority of the given router is automatically adjusted (e.g., reduced) for a subsequent election process. Thus, for example, if the given router is connected to multiple network segments, the election of the given router on a first network segment as an elected router (e.g., an OSPF DR) reduces the priority of the given router for an election process on another network segment. As a result, an automated self-balancing way of selecting elected routers is provided to balance the role of elected routers across a larger number of routers. The self-balancing is achieved since the priorities of a router elected as a DR in one election process (for a first network segment) is automatically reduced so that the router is less likely to be elected as a DR in the next election process (for a second network segment).

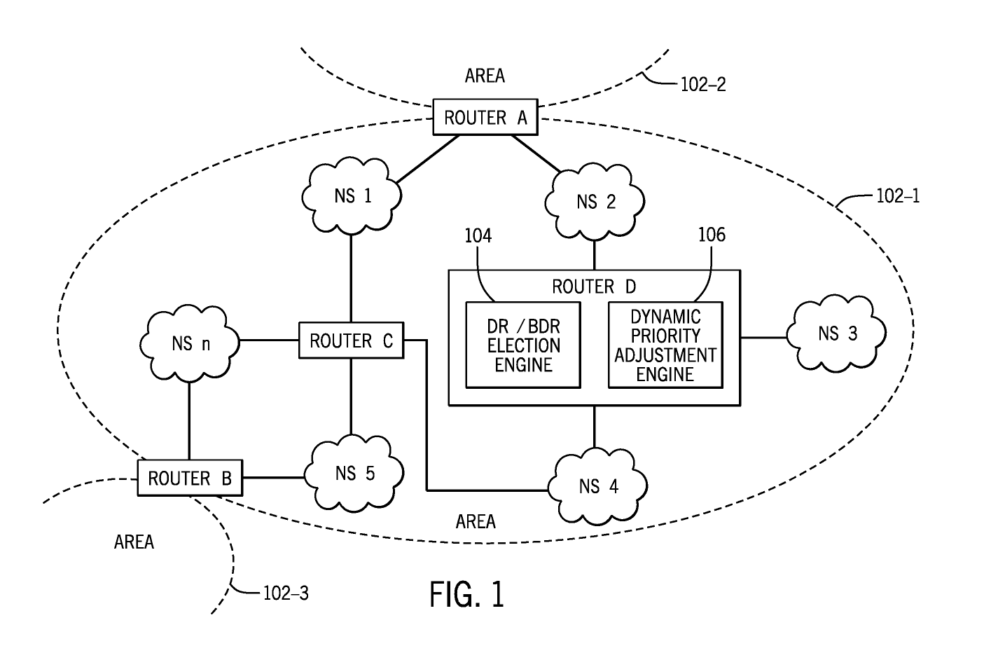

FIG. 1 is a block diagram of a portion of an OSPF network. An OSPF network can be subdivided into multiple routing areas (or more simply “areas”). An area refers to a logical grouping of devices and network segments. FIG. 1 shows areas 102-1, 102-2, and 102-3. In the example of FIG. 1, the area 102-1 includes network segments (NS) 1, 2, 3, 4, 5, and n, where n represents the number of network segments in the area 102-1. Although multiple network segments are shown as being part of the area 102-1, it is noted that in other examples, the area 102-1 can include just one network segment, or some other different number of network segments.

The area 102-1 also includes routers A, B, C, and D. The routers C and D are connected to network segments within the area 102-1. Routers A and B are connected to network segments within the area 102-1 as well as network segments in respective different areas 102-2 and 102-3. More specifically, router A is connected to network segments 1 and 2 in the area 102-1, and a network segment(s) (not shown) in the area 102-2. Router B is connected to network segments 5 and n in the area 102-1, and a network segment(s) (not shown) in the area 102-3.

As shown in FIG. 1, each network segment can be connected to multiple routers. Also, each router may be connected to multiple network segments. In accordance with some implementations of the present disclosure, each of at least some of the routers can include a DR/BDR election engine 104 and a dynamic priority adjustment engine 106.

As used here, an “engine” can include a hardware processing circuit, which can include any or some combination of the following: a microprocessor, a core of a multi-core microprocessor, a microcontroller, a programmable integrated circuit device, a programmable gate array, or any other hardware processing circuit. Alternatively, an “engine” can refer to a combination of a hardware processing circuit and machine-readable instructions (e.g., software and/or firmware) executable on the hardware processing circuit.

The DR/BDR election engine 104 participates in an election process for electing a DR and/or BDR on a network segment. The dynamic priority adjustment engine 106 dynamically adjusts the priority assigned to a router in response to the router being elected as a DR or BDR as part of an election process.

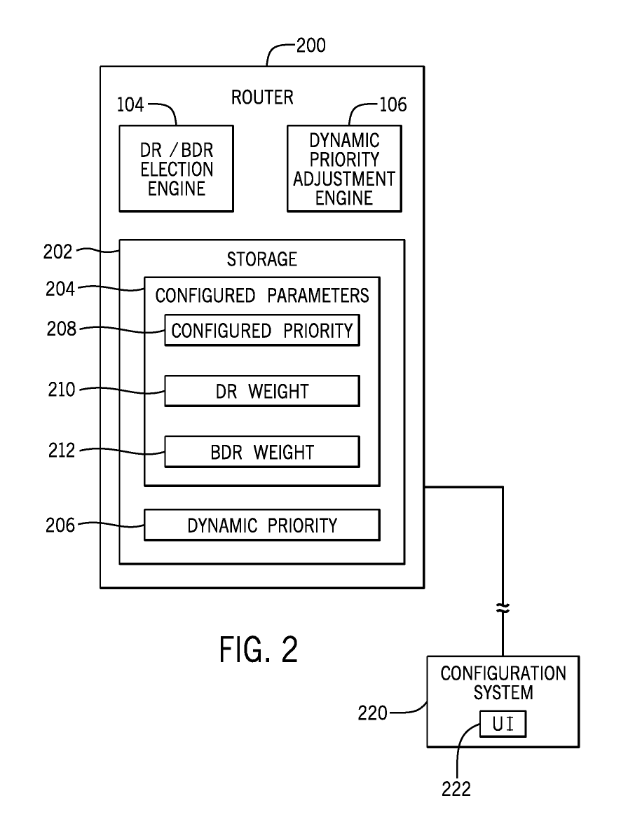

FIG. 2 is a block diagram of an example router 200, which can be any of the routers A, B, C, and D of FIG. 1. The router 200 includes the DR/BDR election engine 104 and the dynamic priority adjustment engine 106. In addition, the router 200 includes a storage 202, which can be implemented using a memory and/or other type of storage device, or using multiple memory devices and/or other types of storage devices.

The storage 202 can store configured parameters 204 and a dynamic priority 206 that is dynamically adjusted by the dynamic priority adjustment engine 106. The configured parameters 204 are configured during a configuration process based on a command (or multiple commands) from a configuration system 220, such as in response to inputs made by a network administrator. The configuration system 220 can be implemented as a computer, for example, or other type of system, connected over a network to the router 200. The configuration system 220 can present a user interface (UI) 222, which can be used by a network administrator to perform configuration of routers, including the router 200. The UI 222 can include a command line interface, a graphical user interface, or another type of interface.

In other examples, instead of setting the configured parameters 204 based on input by a network administrator or other human user, the configured parameters 204 can be automatically set by an automated system (e.g., run under the control of a program).

The configured parameters 204 include a configured priority 208, a DR weight value 210, and a BDR weight value 212. The configured priority 208 is a static priority, which can be the initial priority set by the configuration system 220 and used by the DR/BDR election engine 104 in an election process for electing a DR or BDR.

The DR weight value 210 is used to adjust the dynamic priority 206 in response to the router 200 being elected a DR, and the BDR weight value 212 is used to adjust the dynamic priority 206 in response to the router 200 being elected a BDR.

Note that the configured parameters 204 can be used for a respective area. If the router 200 is connected to multiple areas (e.g., such as router A and router B in FIG. 1), then another set of parameters 204 can be stored in the storage 202 for the other area as well. In cases where the router 200 is connected to different areas, different values of the configured parameters 204 can be set for the different areas served by the router 200. More specifically, a first group of configured parameters 204 is set for a first area, a second group of configured parameters 204 is set for a second area, and so forth.

In some examples, the same DR weight value and BDR weight value can be configured within a given area. For example, for the area 102-1 in FIG. 1, the same DR weight value and the same BDR weight value is set in each of routers A, B, C, and D for the area 102-1. This allows for ease of deployment, since a network administrator or an automated system would not have to determine different DR weight values and BDR weight values for different routers within the same area. However, in other examples, a network administrator or an automated system can configure different DR weight values and BDR weight values for different routers within a given area, but the same configured (static) priority for all routers in the given area.

In some examples, different DR/BDR weight values may be configured based on capabilities of respective routers. A more powerful router (e.g., a router with a larger processing capacity) can be configured with a lower DR/BDR weight value, so that the incremental reduction of the dynamic priority 206 occurs at a smaller step. This is due to the fact that a more powerful router can take on more responsibilities without being overburdened. A less powerful router can be configured with a higher DR/BDR weight value.

In some examples, the configured priority 208 for the router 200 can be set to 0 (or some other specified value), to indicate that the router 200 is not to be considered for a DR or BDR. In this case, the dynamic priority 206 does not change from the static value of the configured priority 208, since the router 200 would not be elected as a DR or BDR.

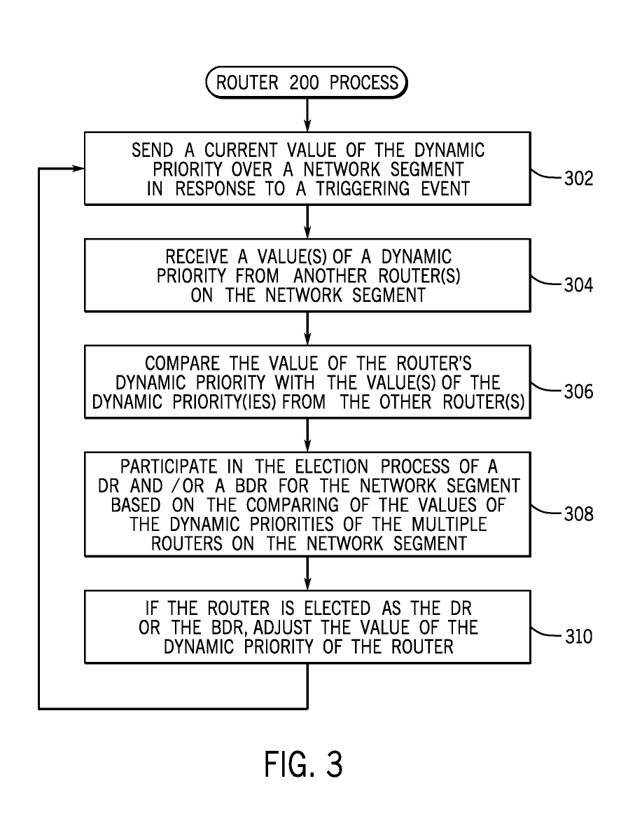

FIG. 3 is a flow diagram of a process performed by the router 200 according to some examples. The tasks of FIG. 3 can be performed in a different order than shown.

The router 200 sends (at 302) a current value of the dynamic priority 206 over a network segment in response to a triggering event. For example, the current value of the dynamic priority 206 can be sent in an OSPF Hello message. If the router 200 has not previously been elected as a DR or BDR, then the dynamic priority 206 that is sent (at 302) has a value equal to the value of the configured priority 208.

Note that the triggering of the sending of the value of the dynamic priority 206 (at 302) can be in response to any of the following events: initial power up or boot up of the router 200, initial connection of the router 200 to the network segment, receipt of a value of a dynamic priority from another router, or any other event that would trigger an election process for a DR and/or BDR.

The router 200 receives (at 304) a value of a dynamic priority from another router on the network segment. For example, the value of the dynamic priority from the other router can be received in an OSPF Hello message from the other router. If there are more than two routers on the network segment, then the router 200 receives values of multiple dynamic priorities from plural other routers on the network segment.

The router 200 (or more specifically, the DR/BDR election engine 104 in the router 200) compares (at 306) the value of its dynamic priority 206 with the value(s) of the dynamic priority(ies) from the other router(s).

The router 200 (or more specifically, the DR/BDR election engine 104 in the router 200) participates (at 308) in the election process of a DR and/or a BDR for the network segment based on the comparing of the values of the dynamic priorities of the multiple routers on the network segment. The router with the highest value of the dynamic priority is elected as the DR, and the router with the second highest value of the dynamic priority is elected as the BDR.

Note that in the election process, if multiple routers on the network segment have the same dynamic priority value (e.g., routers with the highest priority share the same dynamic priority value), then the election of the DR and BDR is based on the router IDs. For example, for routers having the same dynamic priority value, the router with the highest router ID can be elected the DR, and the router with the next highest router ID can be elected the BDR, for example.

If the router 200 is elected as the DR or the BDR, then the value of the dynamic priority of the router 200 is adjusted (at 310), such as by the dynamic priority adjustment engine 106 of the router 200, as follows. If the router 200 is elected as the DR, then the dynamic priority is decremented by the DR weight value 210, i.e., Dynamic Priority=Dynamic Priority−DR Weight.

If the router 200 is elected the BDR, then the value of the dynamic priority is adjusted by decrementing by the BDR weight value 212, i.e., Dynamic Priority=Dynamic Priority−BDR Weight.

Note that the reduction of the value of the dynamic priority 206 does not change the status of the router 200 as the elected DR or BDR for the election process that led to the adjustment of the dynamic priority 206.

The process that returns to task 302, where the router 200 can again send (at 302) the current value of the dynamic priority 206 (as adjusted at 310) in response to a triggering event. This allows for the adjusted dynamic priority 206 to be used in the next election process, for the same network segment or for a different network segment.

By being able to dynamically adjust priorities of routers based on elections as DRs and BDRs, the loads on the routers can be distributed across the routers. Also, by setting DR/BDR weight values differently for different routers, the load distribution can take into account relative capacities of the routers. The load distribution is accomplished whenever an election process is triggered in response to an event.

The load distribution can be performed early during formation of network areas, so that network stability is enhanced. Also, since the dynamic adjustment of priorities takes into account current network conditions, DR/BDR election processes can elect DRs/BDRs in a more efficient manner, even as router failures occur.

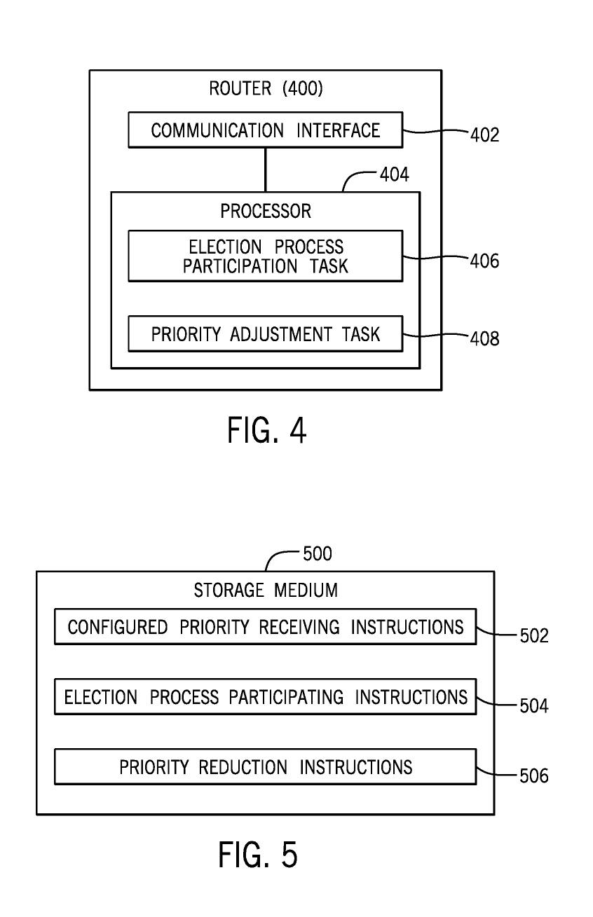

FIG. 4 is a block diagram of a router 400 according to further examples. The router 400 includes a communication interface 402 (including a transceiver and any protocol layers) to communicate over a network (e.g., OSPF network segment). The router 400 further includes a processor 404 (or multiple processors). A processor can include a microprocessor, a core of a multi-core microprocessor, a microcontroller, a programmable integrated circuit, a programmable gate array, or another hardware processing circuit.

The processor 404 can perform various tasks. A processor performing a task can refer to a single processor performing the task or multiple processors performing the task.

The tasks of the processor 404 include an election process participation task 406 that participates in an election process to determine, based on respective priorities assigned to a plurality of routers including the router 400, which of the plurality of routers is an elected router (e.g., an OSPF DR or BDR) responsible for distributing routing information to another router.

The tasks further include a priority adjustment task 408 to, in response to the router 400 being selected as the elected router in the election process, adjust a priority of the router 400 for a subsequent election process.

FIG. 5 is a block diagram of a non-transitory machine-readable or computer-readable storage medium 500 storing machine-readable instructions that upon execution cause a given router to perform various tasks.

The machine-readable instructions include configured priority receiving instructions 502 to receive a configured priority assigned to the first router. The machine-readable instructions further include election process participating instructions 504 to participate in an election process to determine, based on respective priorities assigned to a plurality of routers including the first router, which of the plurality of routers is an elected router responsible for distributing routing information to another router.

The machine-readable instructions additionally includes priority reduction instructions 506 to, in response to the first router being selected as the elected router in the election process, reduce a priority of the first router from the configured priority for a subsequent election process, the reducing of the priority producing a revised priority.

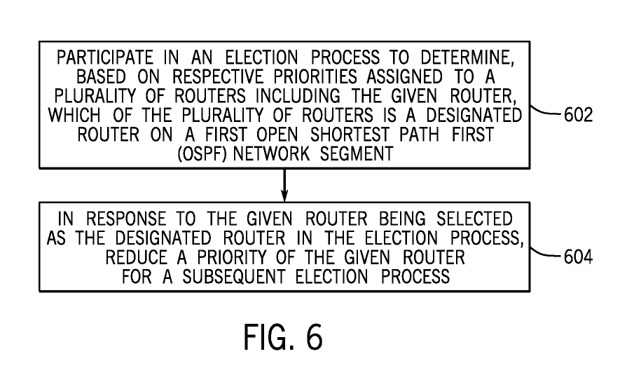

FIG. 6 is a flow diagram of a process of a given router according to further examples. The given router participates (at 602) in an election process to determine, based on respective priorities assigned to a plurality of routers including the given router, which of the plurality of routers is a designated router on a first Open Shortest Path First (OSPF) network segment.

The given router reduces (at 604), in response to the given router being selected as the designated router in the election process, a priority of the given router for a subsequent election process.

The storage medium 500 of FIG. 5 can include any or some combination of the following: a semiconductor memory device such as a dynamic or static random access memory (a DRAM or SRAM), an erasable and programmable read-only memory (EPROM), an electrically erasable and programmable read-only memory (EEPROM) and flash memory; a magnetic disk such as a fixed, floppy and removable disk; another magnetic medium including tape; an optical medium such as a compact disk (CD) or a digital video disk (DVD); or another type of storage device. Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site (e.g., a cloud) from which machine-readable instructions can be downloaded over a network for execution.

In the foregoing description, numerous details are set forth to provide an understanding of the subject disclosed herein. However, implementations may be practiced without some of these details. Other implementations may include modifications and variations from the details discussed above. It is intended that the appended claims cover such modifications and variations.

What is claimed is:

1. A first router comprising:
a communication interface to communicate over a network; and
a processor to:
participate in an election process to determine, based on respective priorities assigned to a plurality of routers including the first router, which of the plurality of routers is an elected router responsible for distributing routing information to another router; and
in response to the first router being selected as the elected router in the election process, adjust a priority of the first router for a subsequent election process.

2. The first router of claim 1, wherein the adjusting of the priority of the first router is based on a specified weight value.

3. The first router of claim 2, wherein the adjusting of the priority of the first router is based on decrementing the priority of the first router by the specified weight value.

4. The first router of claim 2, wherein the processor is to receive the specified weight value during a configuration process of the first router responsive to a command from an administrator.

5. The first router of claim 2, wherein the specified weight value is a first weight value, wherein the first router is part of a plurality of areas in the network, wherein the election process is for a first area of the plurality of areas, and wherein the processor is to further:
for a second area of the plurality of areas,
participate in a further election process to determine, based on respective priorities assigned to a plurality of further routers including the first router, which of the plurality of further routers is an elected router responsible for distributing routing information to another router in the second area; and
in response to the first router being selected as the elected router in the further election process, adjust a priority of the first router for a subsequent election process in the second area based on a second weight value different from the first weight value.

6. The first router of claim 1, wherein the processor is to receive a configured priority for the first router during a configuration process of the first router, the processor to set the configured priority as a priority of the first router in an initial election process of the first router.

7. The first router of claim 1, wherein the processor is to, in response to the first router being selected as an elected router in the initial election process, reduce the priority of the first router from the configured priority.

8. The first router of claim 1, wherein the elected router is a backup elected router.

9. The first router of claim 8, wherein the processor is to:
in response to the first router being selected as the backup elected router:
detect a problem with a current elected router, and
in response to the detecting, take over a role of an elected router.

10. The first router of claim 1, wherein the network comprises an Open Shortest Path First (OSPF) network segment, and the election process is to select a designated router for the OSPF network segment.

11. The first router of claim 1, wherein the adjusting of the priority of the first router for the subsequent election process produces a revised priority, and wherein the processor is to cause a sending of a message including the revised priority to another router for use in the subsequent election process.

12. A non-transitory machine-readable storage medium storing instructions that upon execution cause a first router to:
receive a configured priority assigned to the first router;
participate in an election process to determine, based on respective priorities assigned to a plurality of routers including the first router, which of the plurality of routers is an elected router responsible for distributing routing information to another router; and
in response to the first router being selected as the elected router in the election process, reduce a priority of the first router from the configured priority for a subsequent election process, the reducing of the priority producing a revised priority.

13. The non-transitory machine-readable storage medium of claim 12, wherein instructions upon execution cause the first router to:
send the revised priority to another router;
participate in the subsequent election process using the revised priority; and
in response to the first router being selected as an elected router in the subsequent election process, reduce a priority of the first router from the revised priority for a further election process.

14. The non-transitory machine-readable storage medium of claim 13, wherein the network comprises an Open Shortest Path First (OSPF) network segment, and wherein the revised priority is sent in an OSPF Hello message.

15. The non-transitory machine-readable storage medium of claim 12, wherein the instructions upon execution cause the first router to:
receive a weight value for the first router,
wherein the reducing of the priority uses the weight value to produce the revised priority.

16. The non-transitory machine-readable storage medium of claim 15, wherein the weight value is based on a capacity of the first router.

17. The non-transitory machine-readable storage medium of claim 16, wherein the weight value for the first router having a first capacity is less than a weight value for a second router having a second capacity lower than the first capacity.

18. The non-transitory machine-readable storage medium of claim 12, wherein the first router is to be connected to a plurality of network segments, wherein the election process is for a first network segment of the plurality of network segments, and wherein the instructions that upon execution cause the first router to:
for a second network segment of the plurality of network segments, participate in an election process to determine, based on respective priorities assigned to a plurality of further routers including the revised priority for the first router, which of the plurality of routers is an elected router in the second network segment.

19. A method comprising:
participating, by a first router, in an election process to determine, based on respective priorities assigned to a plurality of routers including the first router, which of the plurality of routers is a designated router on a first Open Shortest Path First (OSPF) network segment; and
in response to the first router being selected as the designated router in the election process, reducing, by the first router, a priority of the first router for a subsequent election process.

20. The method of claim 19, further comprising:
sending, by the first router, a revised priority produced by the reducing in a message to a router connected to a second OSPF network segment; and
participating, by the first router, in a further election process to determine, based on respective priorities assigned to a plurality of further routers including the first router, which of the plurality of further routers is a designated router on the second OSPF network segment.
